(19) United States
(12) Patent Application Publication
(10) Pub. No.: US 2018/0361272 A1
(43) Pub. Date: Dec. 20, 2018

(54) Stackable Chromatography Column Modules

(71) Applicant: GE HEALTHCARE BIOPROCESS R&D AB, UPPSALA (SE)

(72) Inventors: Dan Hermansson, Uppsala (SE); Klaus Gebauer, Uppsala (SE); Mats Lundkvist, Uppsala (SE)

(21) Appl. No.: 15/781,305

(22) PCT Filed: Dec. 7, 2016
(86) PCT No.: PCT/EP2016/080000

§ 371 Date: Jun. 4, 2018

(30) Foreign Application Priority Data
Dec. 16, 2015 (GB) 1522177.3

(51) Int. Cl. B01D 15/18; G01N 30/88; G01N 30/46; G01N 30/60; B01D 15/22

(52) U.S. Cl. CPC B01D 15/1871; G01N 30/88; G01N 30/465; G01N 30/6091; B01D 15/22; G01N 2030/8881; G01N 30/6039

(57) ABSTRACT

The invention discloses a chromatography column module stackable with like chromatography modules, comprising a column chamber (2) fluidically connected to a column inlet 3) and a column outlet (4), wherein the column inlet and outlet each comprise a valve (5), arranged to move from a closed position to an open position upon connection of the column inlet or outlet with a) a column outlet or inlet of a like chromatography module or b) with an outlet or inlet of a fluidics plate. The invention further discloses a stack of chromatography column modules and the use of the stack for separation of biomolecules.

### TECHNICAL FIELD OF THE INVENTION

The present invention relates to chromatography columns and in particular to stackable chromatography column modules for processing of biopharmaceuticals. The invention also relates to stacks of chromatography column modules and to methods of using such stacks for purification of biomolecules.

### BACKGROUND OF THE INVENTION

The use of pre-packed stackable chromatography column modules or cartridges has a potential to increase flexibility in pilot and process scale bio-manufacturing. The flexibility arises from the ability to build a larger system for the required capacity and contaminant clearance from a number of standardized modules. The modules are supplied pre-packed, which means that the user does not have to perform any complex packing operations and they can be used as disposable products, i.e. they can be discarded after one or more batches or campaigns.

An issue with pre-packed modules is that the chromatography resin is packed in a liquid and when the modules are connected to each other or to the system, liquid may leak out. This is also an issue when disconnecting the modules after use, particularly if they have been used in the processing of biohazardous or toxic substances. Further, in many bioprocessing operations a high degree of hygiene or even sterility is required. For this reason it is also desirable to avoid any contamination of the module content from the exterior during connection.

Accordingly there is a need for convenient solutions allowing leak-free connection/disconnection of chromatography column modules and also for solutions allowing sanitary connection of the modules.

### SUMMARY OF THE INVENTION

One aspect of the invention is to provide a stackable chromatography column module that can conveniently be connected with like chromatography column modules in a stack. This is achieved with a module as defined in the claims.

One advantage is that the chromatography column modules can be connected and/or disconnected without leakage of liquid from the modules.

A second aspect of the invention is a stack of chromatography column modules that can be assembled and/or disassembled without leakage of liquid. This is achieved with a stack as defined in the claims.

A third aspect of the invention is to provide a use of the chromatography column module stack for separation of a biomolecule. This is achieved with a use as defined in the claims.

Further suitable embodiments of the invention are described in the dependent claims.

### DRAWINGS

FIG. 1 shows a cross section of a chromatography column module of the invention (side view).

FIG. 2 shows a chromatography column module of the invention (side view).

FIG. 3 shows a cross section of a stack of two chromatography column modules of the invention (side view).

FIG. 4 shows a stack of two chromatography column modules of the invention (side view).

FIG. 5 shows a detailed cross section of an inlet and an outlet of two connected chromatography column modules of the invention (side view).

FIG. 6 shows a detailed cross section of an inlet and an outlet of two chromatography column modules of the invention before connection (side view).

FIG. 7 shows a detailed cross section of the aseptic connector inlet and outlet of two chromatography column modules of the invention before connection (side view).

FIG. 8 shows a detailed cross section of the aseptic connector inlet and outlet of two chromatography column modules of the invention before connection (side view).

FIG. 9 shows a stack of chromatography column modules and a fluidics plate according to the invention (schematic side view).

FIG. 10 shows a detailed cross section of an inlet and an outlet of two chromatography column modules of the invention before connection (side view).

FIG. 11 shows a detailed cross section of an inlet and an outlet of two connected chromatography column modules of the invention (side view).

### DETAILED DESCRIPTION OF EMBODIMENTS

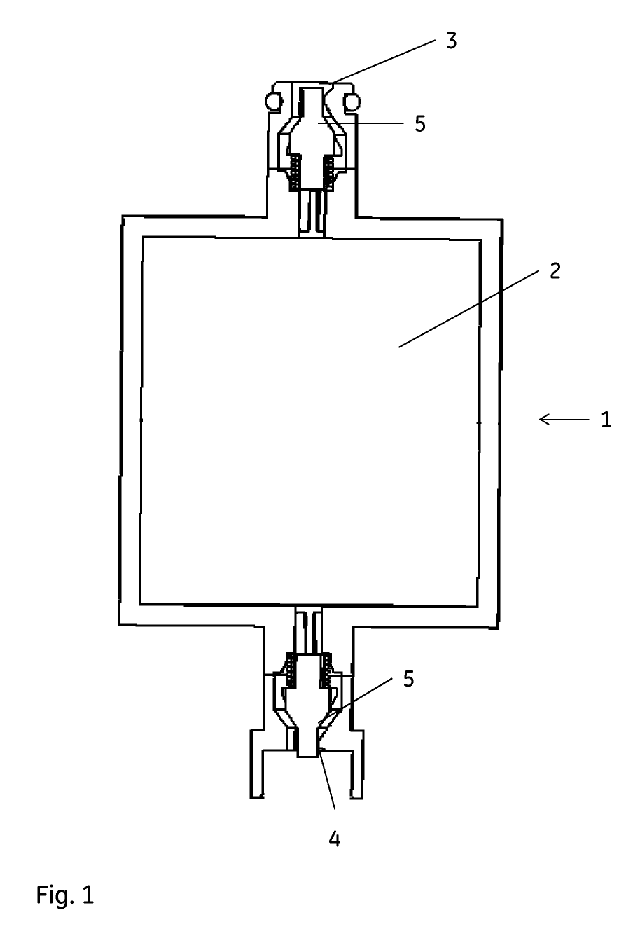

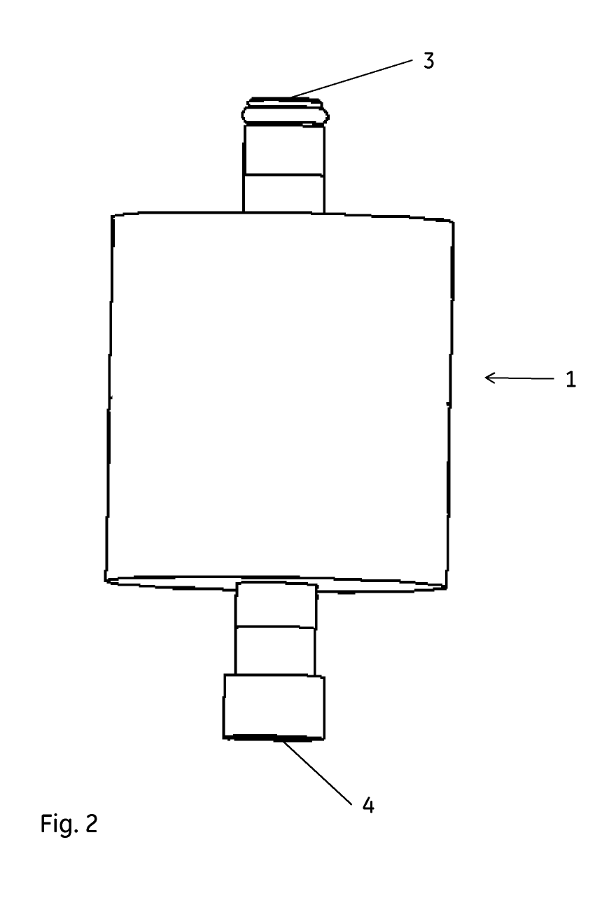

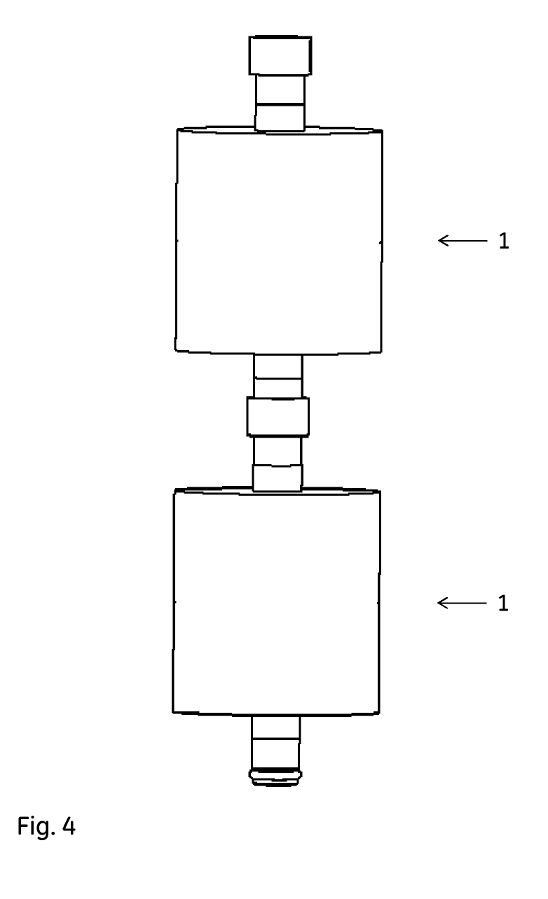

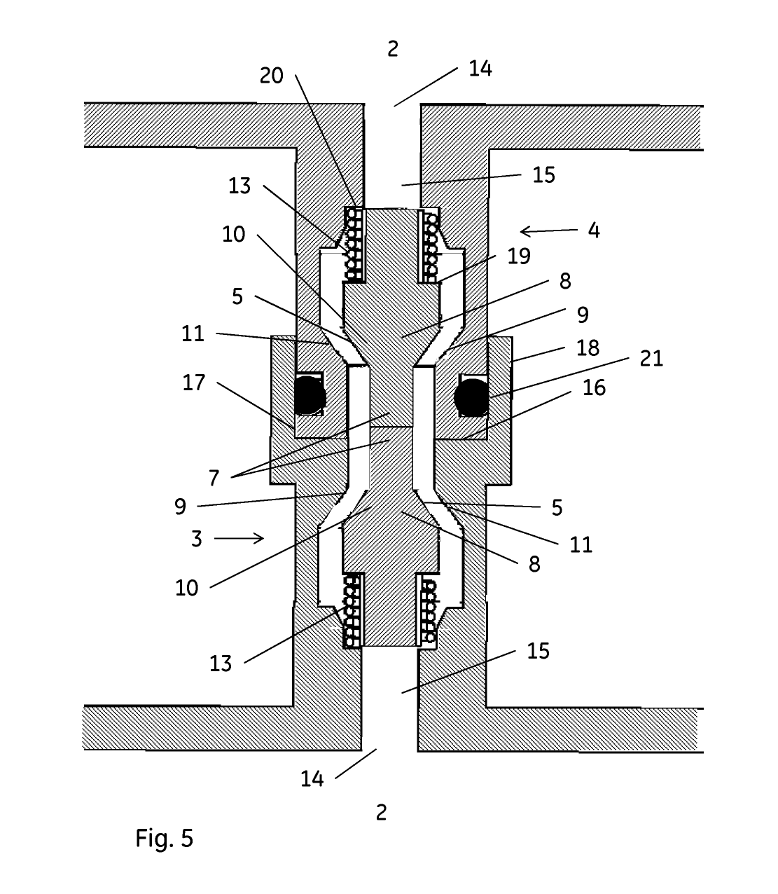

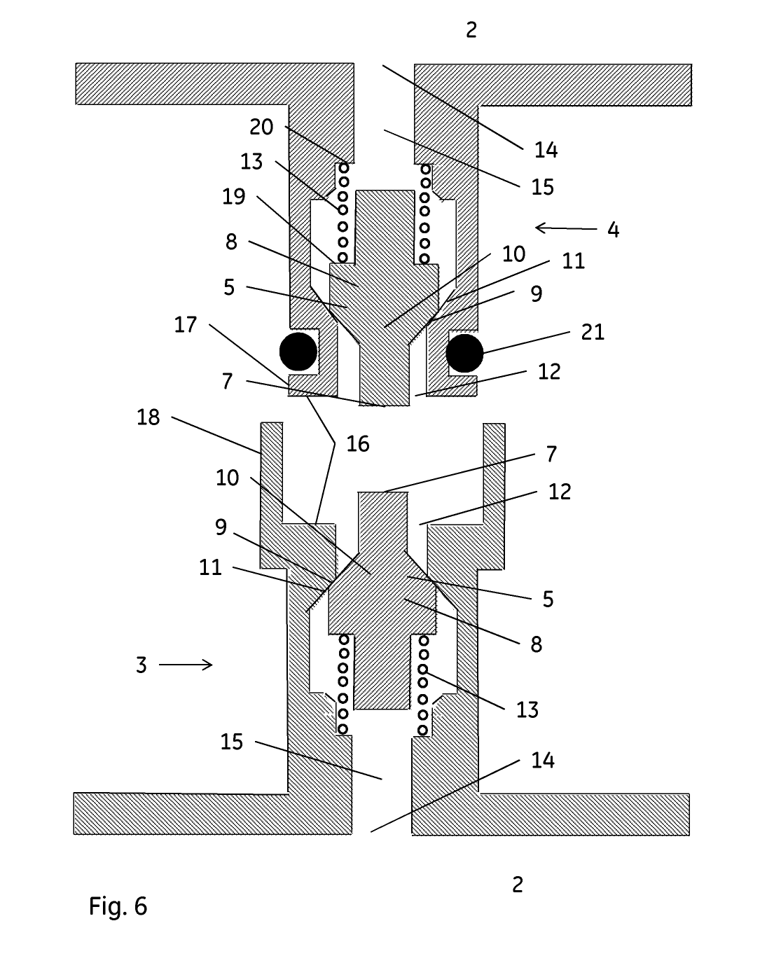

In one aspect, illustrated by FIGS. 1-9, the present invention discloses a chromatography column module 1 stackable with like chromatography modules. The chromatography column module comprises a column chamber 2, which can typically contain a packed bed of chromatography resin particles and a liquid. The column chamber is fluidically connected to a column inlet 3;103;203;303 and a column outlet 4;104;204;304, wherein the column inlet and the column outlet each comprises a valve 5;305, arranged to move from a closed position to an open position upon connection of the column inlet or outlet with a) a column outlet or inlet of a like chromatography module or b) with an outlet or inlet of a fluidics plate 6. Both inlets and outlets may have a circular cross section and typically comprise an inner aperture 14, in fluidic connection with the column chamber, a bore 15 allowing fluidic connection with an outer aperture 12 in an abutment surface 16 and a valve member 8;308 which closes the bore when in a closed position and leaves the bore open when in an open position. The inlet may comprise a male connector 17, e.g. with a sealing O-ring 21, and the outlet a female connector 18, or vice versa, for coupling with a like chromatography module or a fluidics plate with the outer apertures 12 and abutment surfaces 16 of the respective inlets and outlets in contact with each other. The fluidics plate 6 can e.g. be a flow control block as described in detail in copending application PCT EP2015/065311 (hereby incorporated by reference in its entirety), for allowing flexible connection of modules in various combinations of parallel and/or serial mode. It can however also be a plate comprising e.g. a concentration detector and/or a valve 50 and a branch line 51 for diverting or adding flow upon certain conditions, useful e.g. in continuous chromatography setups such as periodic countercurrent chromatography (see e.g. US20120091063A1, hereby incorporated by reference in its entirety). Each of the column inlet and the column outlet can suitably further comprise a valve opening member 7;307 arranged to act upon the valve of a column inlet or outlet of a like chromatography column module or a flow plate upon connection. The valve opening member can typically engage the valve member mechanically when an inlet and an outlet are connected and urge the valve member into an open position. The valve may e.g. comprise a spring-loaded valve member 8;308 resting on a valve seat 9;309 when the valve is in the closed position and wherein, upon connection with a column inlet or outlet of a like chromatography column module, a valve opening member 7;307 causes the valve to move to an open position by urging the valve member away from the valve seat, creating an open passageway through the inlet or outlet. The valve member may e.g. comprise a frustoconical segment 10;310, which when the valve is in the closed position is in sealing abutment against a frustoconical bore segment 11;311 of the column inlet or outlet bore 15. The spring-loading may e.g. be achieved by a spring 13, engaging a valve member annular ring 19 and a bore annular rim 20. The valve opening member may be integral with the valve member and may extend through an outer aperture 12 of the column inlet and outlet respectively, when in a non-connected state (i.e. when the valve is in a closed position). Thus, when the inlet and outlet are connected and the abutment surfaces 16 are brought into contact, both valve opening members are pushed inwards (in a direction towards the inner apertures), urging both valve members 8 away from the valve seats 9 into an open position.

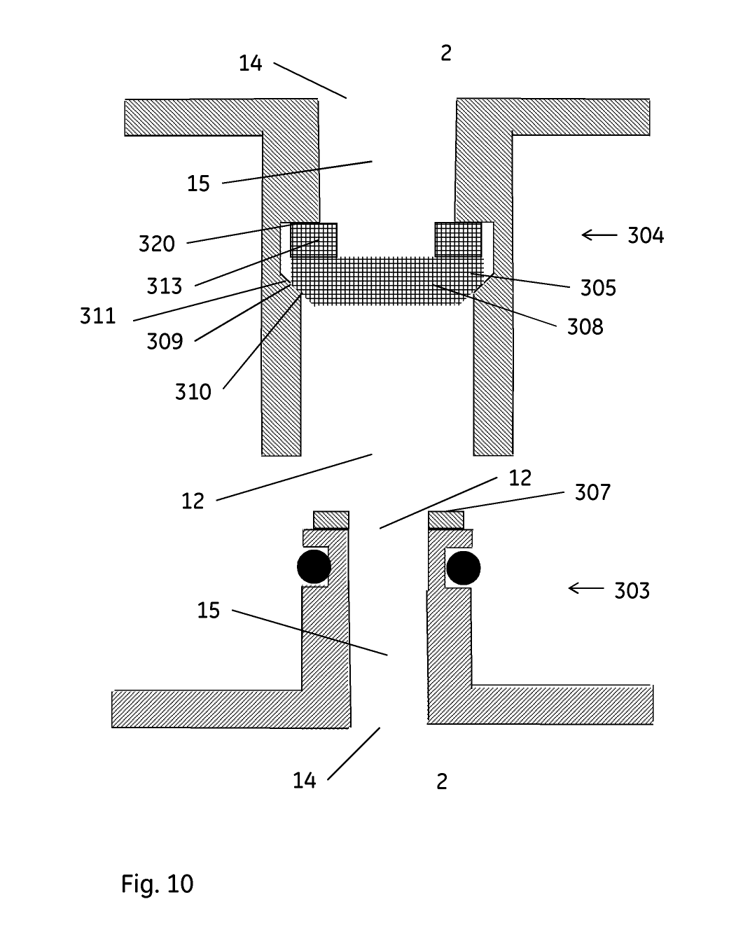

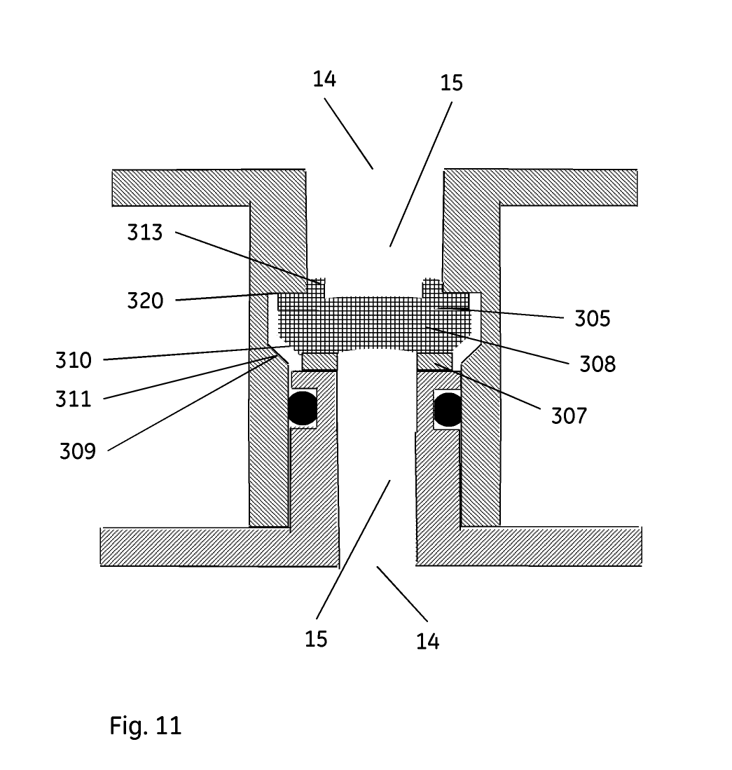

In certain embodiments, illustrated by FIGS. 10 and 11, the valve member 308 is elastic, e.g. made from an elastomer such as silicone rubber, and intrinsically spring-loaded by means of integral projections 313 (e.g. rectangular or sector-shaped) extending from the valve member in the direction towards the inner aperture and engaging a bore annual rim 320. In a closed position, a frustoconical segment 310 of the valve member can be in sealing abutment with a frustoconical bore segment 311 of the column inlet or outlet bore 15. On connection with another column inlet or outlet, a valve opening member, e.g. projections 307 on the inlet or outlet, urges the valve member in a direction towards the inner aperture, causing frustoconical segment 310 to move away from frustoconical bore segment 311 such that the valve is in an open position and liquid can flow through the bore, between the projections 307, through the space between segments 310 and 311 and between the projections 313. Although FIGS. 10 and 11 show a female connector with the valve member and a male connector with the valve opening member, alternative constructions are possible, e.g. with the valve member in a male connector and the valve opening member extending from a female connector.

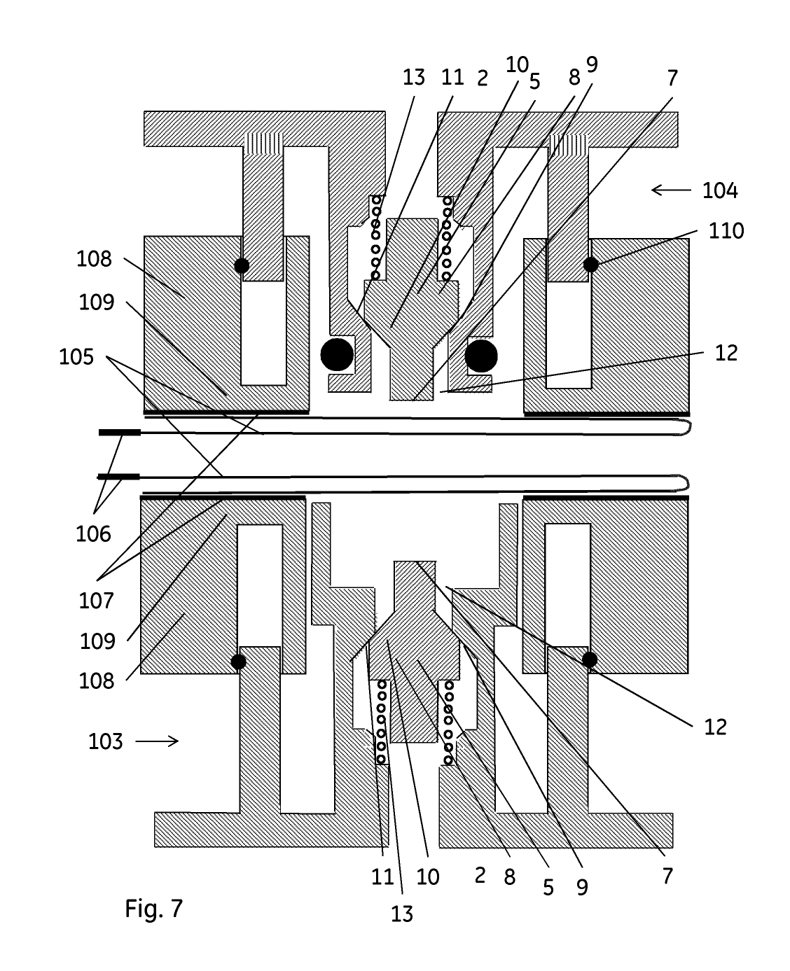

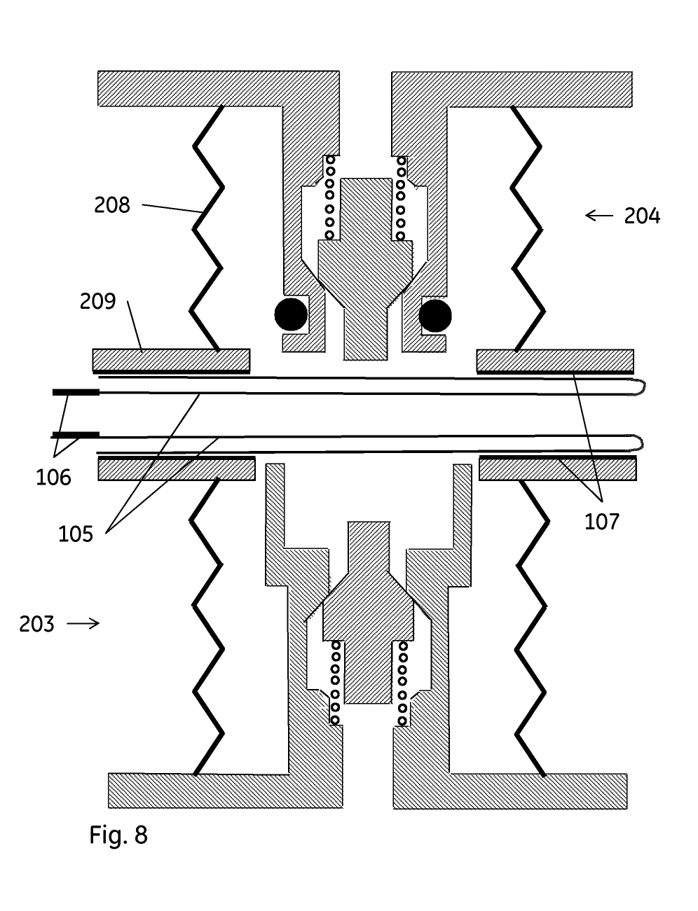

In some embodiments, illustrated by FIGS. 7 and 8, each column inlet 103;203 and outlet 104;204 is an aseptic connector, comprising a folded over protective film 105 arranged to be pulled out together with a corresponding film 105 in an abutting connector, typically using tabs 106. The folded over protective film may releasibly adhere to a flange 109;209 mounted on, or forming an integral part of, an axially movable or deformable outer side wall 108;208 surrounding the column inlet or outlet. The film can e.g. be attached with a pressure-sensitive adhesive on a foam donut 107 (or another suitable compressible substrate), attached to the flange surface. The outer side wall 108 can e.g. be telescopically movable in an axial direction relative to the column inlet or outlet, e.g. using an O-ring 110 for sealing. Alternatively, the outer side wall 208 may comprise a collapsible bellows or a flexible diaphragm that can be rolled or otherwise deformed. The outer side wall may in some embodiments be arranged to be removed after connection. This can e.g. be achieved by a line of weakening in the wall and a tab arranged to rupture the wall along the line of weakening when the tab is pulled. In other embodiments, the wall may be left in place after connection. It may then form a secondary enclosure around the connection, containing any accidental liquid leakage. If the wall is flexible and weldable, e.g. in the case of a thermoplastic bellows, it is also possible to achieve a completely enclosed disconnection of the modules. The inlet and outlet can be disconnected from each other, the bellows extended and cut and sealed using sterile welding equipment commonly available in bioprocess facilities with single use equipment.

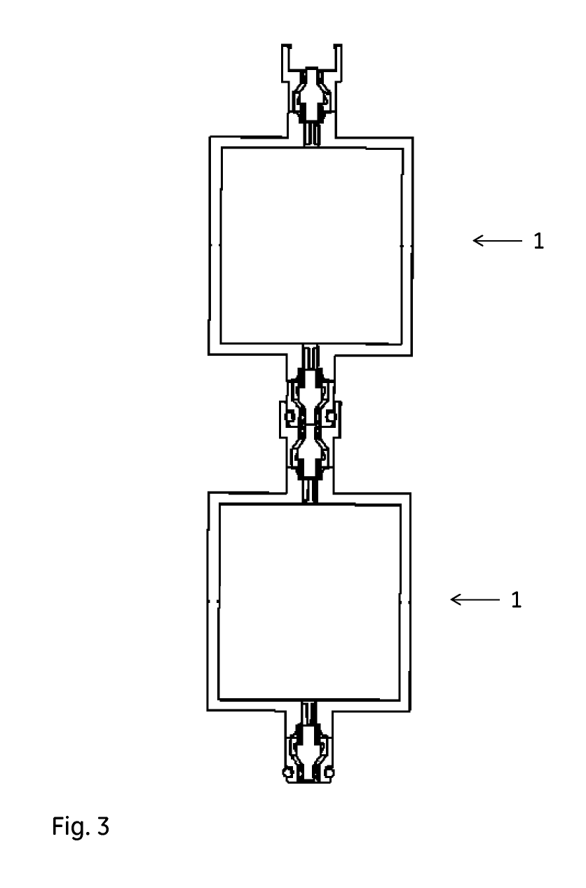

In a second aspect, illustrated by FIGS. 3-5, the invention discloses a stack of at least two like chromatography column modules 1 as described above, wherein a column inlet of a first chromatography column module is fluidically connected with a column outlet of a second chromatography column module. The chromatography column modules may be packed with the same chromatography resin or they may be packed with different resins, allowing more than one step to be carried out with the stack.

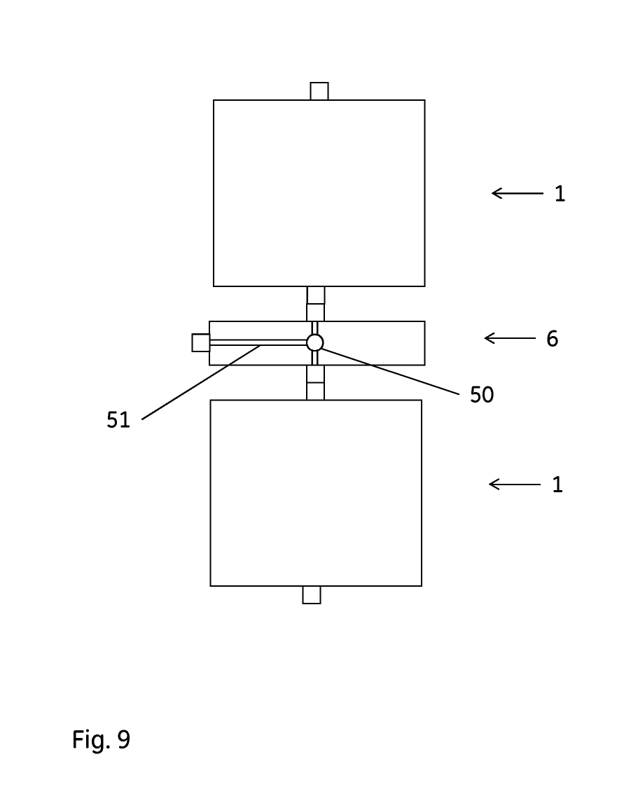

In a third aspect, illustrated by FIG. 9, the invention discloses a stack of at least two like chromatography column modules 1 as described above, wherein a column inlet of a first chromatography column module is fluidically connected with an outlet of a fluidics plate 6 and wherein an inlet of the fluidics plate is fluidically connected with a column outlet of a second chromatography column module. As above, the column modules may be packed with the same resin or with different resins.

In a fourth aspect the present invention discloses use of the stack as described above for separation of a biomolecule. The biomolecule can be e.g. a protein (e.g. an immunoglobulin), a peptide, a virus or a nucleic acid to be used as a biopharmaceutical. The biomolecule may be present in a crude feed, e.g. a clarified cell broth or in a semi-purified form, e.g. recovered from a previous chromatography step. The separation may involve clearance of impurities or contaminants such as host cell proteins, viruses, endotoxins or aggregates, fragments, variants etc. of the biomolecule. The use can involve a method comprising the steps of i) assembling a stack as discussed above, ii) passing an equilibration buffer through the stack, iii) passing a sample containing a biomolecule through the stack and iv) either recovering the biomolecule in the sample after passage of the stack in step iii) or passing an elution buffer through the stack and recovering the biomolecule in the elution buffer after passage of the stack.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All patents and patent applications mentioned in the text are hereby incorporated by reference in their entireties as if individually incorporated.

1. A chromatography column module stackable with like chromatography modules, comprising a column chamber fluidically connected to a column inlet and a column outlet, wherein said column inlet and said column outlet each comprise a valve, arranged to move from a closed position to an open position upon connection of said column inlet or outlet with a) a column outlet or inlet of a like chromatography module or b) with an outlet or inlet of a fluidics plate.

2. The chromatography column module of claim 1, wherein each of the column inlet and the column outlet further comprises a valve opening member arranged to act upon said valve of a column inlet or outlet of a like chromatography column module upon connection.

3. The chromatography column module of claim 1, wherein said valve comprises a spring-loaded valve member resting on a valve seat when the valve is in the closed position and wherein, upon connection with a column inlet or outlet of a like chromatography column module, a valve opening member causes said valve to move to an open position by urging said valve member away from said valve seat.

4. The chromatography column module of claim 3, wherein said valve member comprises a frustoconical segment, which when the valve is in the closed position is in sealing abutment against a frustoconical bore segment of said column inlet or outlet.

5. The chromatography column module of claim 2, wherein said valve opening member is integral with said valve member.

6. The chromatography column module of claim 2, wherein said valve opening member extends through an outer aperture of said column inlet or outlet.

7. The chromatography column module of claim 3, wherein said valve member is elastic and is intrinsically spring-loaded by means of integral projections extending from the valve member and engaging a bore annular rim.

8. The chromatography column module of any preceding claim, wherein each column inlet and outlet is an aseptic connector, comprising a folded over protective film arranged to be pulled out together with a corresponding film in an abutting connector.

9. The chromatography column module of claim 8, wherein said folded over protective film releasibly adheres to a flange mounted on, or forming an integral part of, an axially movable or deformable outer side wall surrounding said column inlet or outlet.

10. The chromatography column module of claim 9, wherein said outer side wall is telescopically movable relative to said column inlet or outlet.

11. The chromatography column module of claim 9, wherein said outer side wall comprises a bellows.

12. The chromatography column module of claim 11, wherein said bellows is thermoplastic.

13. The chromatography column module of claim 8, wherein said outer side wall is arranged to be removed after connection.

14. A stack of at least two like chromatography column modules of claim 1, wherein a column inlet of a first chromatography column module is fluidically connected with a column outlet of a second chromatography column module.

15. A stack of at least two like chromatography column modules of claim 1, wherein a column inlet of a first chromatography column module is fluidically connected with an outlet of a fluidics plate and wherein an inlet of said fluidics plate is fluidically connected with a column outlet of a second chromatography column module.

16. Use of the stack according to claim 14 for separation of a biomolecule.
